(19) United States
(12) Patent Application Publication
(10) Pub. No.: US 2026/0359966 A1
(43) Pub. Date: Nov. 12, 2026

(54) WELDING STATE DETERMINATION METHOD AND DETERMINATION SYSTEM

(71) Applicant: PANASONIC ENERGY CO., LTD., Moriguchi-Shi, Osaka (JP)

(72) Inventors: Sei Inamura, Nara (JP); Shunsuke Uegaki, Nara (JP)

(73) Assignee: PANASONIC ENERGY CO., LTD., Moriguchi-Shi, Osaka (JP)

(21) Appl. No.: 19/122,436

(22) PCT Filed: Oct. 17, 2023
(86) PCT No.: PCT/JP2023/037507

§ 371 Date: Apr. 18, 2025

(30) Foreign Application Priority Data
Oct. 31, 2022 (JP) 2022-174341

(51) Int. Cl. G06T 7/00; B23K 26/03

(52) U.S. Cl. CPC G06T 7/001; B23K 26/032; G06T 2207/20081; G06T 2207/30136; G06T 2207/30164

(57) ABSTRACT

This welding state determination method comprises: a step for acquiring a first image which is an image of a welded spot; a step for measuring the intensity of light being emitted from a welded member that has been irradiated with a laser beam, along the moving direction of the laser beam; a step for creating a second image by converting, into an image, measurements of the intensity of light along the moving direction of the laser beam; and a step for determining the state of the welded spot on the basis of determination images that include the first image and the second image.

### TECHNICAL FIELD

The present disclosure relates to a welded state determination method and determination system.

### BACKGROUND

Conventionally, in order to determine a welded state of a laser-welded object, welding quality determination has been made by estimating the weld strength and the like based on image data of the welded portion and the intensity of reflected light and plasma light emitted when a laser is irradiated onto the object (see, for example, Patent Literature 1 and 2). In recent years, welded states have also been determined based on machine learning of artificial intelligence (AI) (see, for example, Patent Literature 3). Patent Literature 3 describes determining a welded state by AI processing based on image data of a laser-welded portion of a plate material captured by a camera.

### CITATION LIST

### Patent Literature

PATENT LITERATURE 1: Japanese Unexamined Patent Application Publication No.

2000-061672
PATENT LITERATURE 2: Japanese Unexamined Patent Application Publication No. 2005-095942
PATENT LITERATURE 3: Japanese Unexamined Patent Application Publication No. 2020-044546

### SUMMARY

When determining a welded state of a laser-welded object, accuracy of the determination can be improved by making the determination based on the intensity of reflected light of the irradiated laser, plasma light generated at the welded portion, and the like, in addition to image data of the welded portion. However, conventional determination methods have a problem in that non-defective products may be determined as defective depending on the threshold value, and further improvement in determination accuracy is required.

A welded state determination method according to the present disclosure is a determination method for determining a welded state of a welded portion that has been melted and solidified by moving a laser relative to a welding workpiece and irradiating the laser onto the welding workpiece. The determination method includes: a step of acquiring a first image which is an image of the welded portion; a step of measuring, along a direction of movement of the laser, intensity of light emitted from the welding workpiece irradiated with the laser; an imaging processing step of imaging the intensity of the light in a manner corresponding to the direction of movement of the laser and thereby creating a second image; and a determination step of determining a state of the welded portion based on an image for determination use containing the first image and the second image.

A welded state determination system according to the present disclosure is a determination system for determining a welded state of a welded portion that has been melted and solidified by moving a laser relative to a welding workpiece and irradiating the laser onto the welding workpiece. The determination system includes: an image acquisition means configured to acquire a first image which is an image of the welded portion; a measuring means configured to measure, along a direction of movement of the laser, intensity of light emitted from the welding workpiece irradiated with the laser; an imaging processing means configured to image the intensity of the light in a manner corresponding to the direction of movement of the laser and thereby create a second image; and a determination means configured to determine a state of the welded portion based on the first image and the second image.

According to the method disclosed herein, the intensity of light emitted from a welding workpiece irradiated with a laser is imaged and used together with an image of the welded portion in determining the welded state, so that highly accurate determination is possible. Further, the above-described imaging facilitates determination of the welded portion in a multifaceted approach using machine learning of artificial intelligence (AI).

### BRIEF DESCRIPTION OF DRAWINGS

FIG. 1 is a block diagram showing a schematic configuration of a welded state determination system according to an example embodiment.

FIG. 2 is a diagram showing an example welded portion.

FIG. 3 is a flowchart showing a procedure of a determination method according to an example embodiment.

FIG. 4 is a schematic diagram for explaining a determination method according to an example embodiment.

### DESCRIPTION OF EMBODIMENTS

Example embodiments of a welded state determination method and determination system according to the present disclosure will be described in detail below by reference to the drawings. Configurations formed by selectively combining a plurality of embodiments and variants described below are included within the scope of the present disclosure.

In the present embodiments, a battery is referred to as an example of a welding workpiece. Specifically, determination is made regarding the welding quality of a laser-welded portion 102 between a sealing assembly 100 and a lead 101 of a cylindrical battery. However, the object of the welded state determination method and determination system according to the present disclosure is not limited to the welded portion 102, and may alternatively be a laser-welded portion of a different member constituting a battery, or a laser-welded portion of an article other than a battery. The welded state determination method and determination system according to the present disclosure can be applied widely to laser-welded portions formed by irradiating a laser (or laser light) onto a welding workpiece while moving the laser relative thereto.

FIG. 1 is a block diagram showing a schematic configuration of a welded state determination system 10 according to an example embodiment. As shown in FIG. 1, the determination system 10 includes a first processing unit 11, a second processing unit 12, and a third processing unit 13 as computers configured to execute processing for determining the quality of a welded portion 102. The determination system 10 further includes a camera 20 and a sensor 21. The camera 20 is an image acquisition means configured to acquire an image of the welded portion 102. In the present specification, an image captured by the camera 20 is referred to as a first image. The sensor 21 is a light intensity measuring means configured to measure, along the direction of movement of a laser, the intensity of light emitted from a welding workpiece irradiated with the laser.

As will be described in more detail later, the determination system 10 includes: an imaging processing means configured to image, in a manner corresponding to the direction of movement of the laser, measured values of the intensity of light emitted from the welding workpiece irradiated with the laser, and thereby create a second image; and a determination means configured to determine the state of the welded portion 102 based on the first and second images. In the determination system 10, the second processing unit 12 is the imaging processing means, and the third processing unit 13 is the determination means. The first processing unit 11 performs a trimming process of importing the image captured by the camera 20 and cutting out only a part thereof necessary for determining the quality of the welded portion 102.

For example, the determination system 10 includes three computers. That is, the first processing unit 11, the second processing unit 12, and the third processing unit 13 are configured as separate computers. In the example shown in FIG. 1, the first processing unit 11 and the third processing unit 13 are communicatively connected, and the second processing unit 12 and the third processing unit 13 are communicatively connected. The computers constituting the determination system 10 may be connected via a local area network (LAN) or via a wide area network (WAN) such as the Internet. The functions of the respective processing units can also be realized by a single computer. Alternatively, the functions of the respective processing units may be realized by four or more computers.

The computer constituting each processing unit includes: a memory unit that stores programs for executing the functions of the processing unit, parameters necessary for calculations and processing, acquired image data, and the like; and a calculation unit that reads out the programs to perform quality determination of the welded portion and processing required for the determination. For example, the calculation unit is composed of a processor such as a central processing unit (CPU). No particular limitation is imposed on the configuration of the computer constituting each processing unit so long as the configuration is capable of executing quality determination of the welded portion.

The determination system 10 is, for example, annexed to a laser welding device that welds together the sealing assembly 100 and the lead 101. In that case, inspection of the welded state can be performed immediately following the welding process. At least part of the configuration of the determination system 10 may be incorporated in the laser welding device, and in the present embodiment, the light intensity measuring means is incorporated in a laser head 52 of the laser welding device. Further, the second processing unit 12 is communicatively connected to a laser oscillator 50, and acquires from the laser oscillator 50 measured values of laser output irradiated onto the welding workpiece.

The laser welding device includes the laser oscillator 50, an optical fiber 51, and the laser head 52. A laser output from the laser oscillator 50 is transmitted to the laser head 52 via the optical fiber 51, and is irradiated to a welding point from the laser head 52 arranged near the sealing assembly 100 and the lead 101, each of which is the welding workpiece. As the laser oscillator 50, a fiber laser oscillator is generally used, but a YAG laser oscillator, a CO₂ laser oscillator, and the like may also be used.

The laser head 52 includes a mirror 53, which reflects the laser output from the laser oscillator 50 in the direction of the welding workpiece and transmits light emitted from the welding workpiece. Furthermore, a condenser lens, a filter, and the like are generally provided in the laser head 52. The laser welding device includes, for example, a drive device that causes scanning movement of at least one of the laser head 52 and a table on which the welding workpiece is placed, and a control device that controls operation of the welding device including the laser oscillator 50, the drive device, and the like.

As described above, the determination system 10 measures the intensity of light emitted from the welding workpiece irradiated with the laser, and images the measured light intensity. The determination system 10 then determines the welded state using a second image obtained by the imaging in addition to the first image of the welded portion 102 captured by the camera 20. The determination of the welded state is performed to determine whether or not there is a welding defect. Although the determination can be made by visual inspection by an inspector, the determination is made preferably by image analysis using a computer, and more preferably using an artificial intelligence (AI) model. In the determination system 10, by imaging the intensity of light emitted from the welded portion 102, data suitable for AI processing is provided to the third processing unit 13.

The determination system 10 includes the sensor 21 and a spectroscopic unit 22 as the light intensity measuring means for measuring the intensity of the light. The light emitted from the welding workpiece irradiated with the laser includes, for example, plasma light and thermal radiation light. Further, the light emitted from the welding workpiece irradiated with the laser is assumed to include reflected light of the laser. The determination system 10 performs imaging processing on at least one selected from plasma light, thermal radiation light, and reflected laser light, and more preferably on all of the foregoing lights, and uses the imaged result to determine the welded state. In the determination system 10, there is provided the spectroscopic unit 22 that spectrally disperses the above lights. In the example shown in FIG. 1, the sensor 21 and the spectroscopic unit 22 are mounted on the laser head 52.

Plasma light generated during laser welding causes absorption and refraction of the laser. For this reason, plasma light is considered to reduce the energy of the laser irradiated onto the welding workpiece, and affects, for example, the penetration depth of the welded portion. Accordingly, at a welding point where the state of plasma light has changed significantly, there is possibility that a defect such as insufficient penetration depth has occurred. Similarly, thermal radiation light (or near-infrared radiation) generated from the welded portion and reflected laser light reflected off of the welded portion are useful for determining the welded state, and significant changes in thermal radiation light and reflected light allow to infer possibility of a defect in the welded portion.

Although a single sensor 21 is shown in FIG. 1, the sensor 21 includes a first sensor that receives plasma light and measures its intensity, a second sensor that receives thermal radiation light and measures its intensity, and a third sensor that receives reflected light of the laser and measures its intensity. Each sensor 21 is, for example, a photodiode having a sensitivity range in the wavelength region of light to be detected, and outputs, as detected information, an electrical signal according to the intensity of the light. As the light intensity measuring means, it is possible to use a device in which the spectroscopic unit and sensors capable of detecting reflected lights of the respective wavelengths are formed into one unit.

In the determination system 10, the detected information of the sensor 21 is transmitted to the second processing unit 12, and the second processing unit 12 performs imaging processing on the measured intensity values of plasma light, thermal radiation light, and reflected light. The second processing unit 12 further acquires, from the laser oscillator 50, measured values of laser output, and performs imaging processing on the measured values.

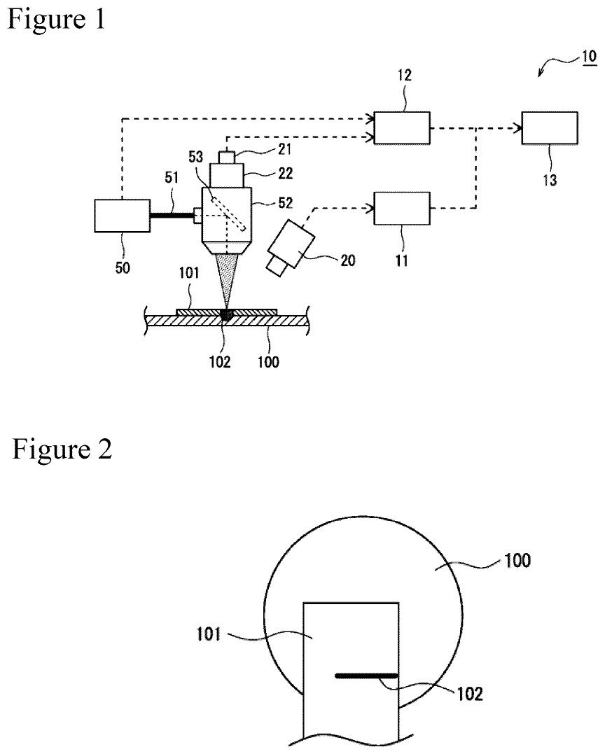

FIG. 2 is a diagram showing the welded portion 102 between the sealing assembly 100 and the lead 101. As shown in FIGS. 1 and 2, the welded portion 102 is formed by irradiating a laser onto a surface of the lead 101 while the lead 101 is placed overlapping the sealing assembly 100. The lead 101 is, for example, a rectangular strip-shaped conductive member connected to the positive electrode, and is made of a metal containing aluminum as a main component. While the thickness and width of the lead 101 can be changed as appropriate depending on the size of the battery and the like, in one example, the thickness is greater than or equal to 50 μm and less than or equal to 500 μm, and the width is greater than or equal to 2 mm and less than or equal to 10 mm. The sealing assembly 100 is thicker than the lead 101, and includes a metal plate to which the lead 101 is welded. The metal plate is made of, for example, a metal containing aluminum as a main component.

In the example shown in FIG. 2, the welded portion 102 extends parallel to the width direction of the lead 101, and is formed the shape of a thin line having a substantially uniform width. The width of the welded portion 102 is, for example, greater than or equal to 1 mm and less than or equal to 4 mm, or greater than or equal to 1.5 mm and less than or equal to 3.5 mm. The welded portion 102 is formed by irradiating a laser onto the welding workpiece while the laser is moved relative to the welding workpiece, and thereby causing the laser-irradiated portion to melt and solidify. The relative movement of the laser with respect to the welding workpiece is carried out by causing scanning movement of at least one of the laser and the table on which the welding workpiece is placed.

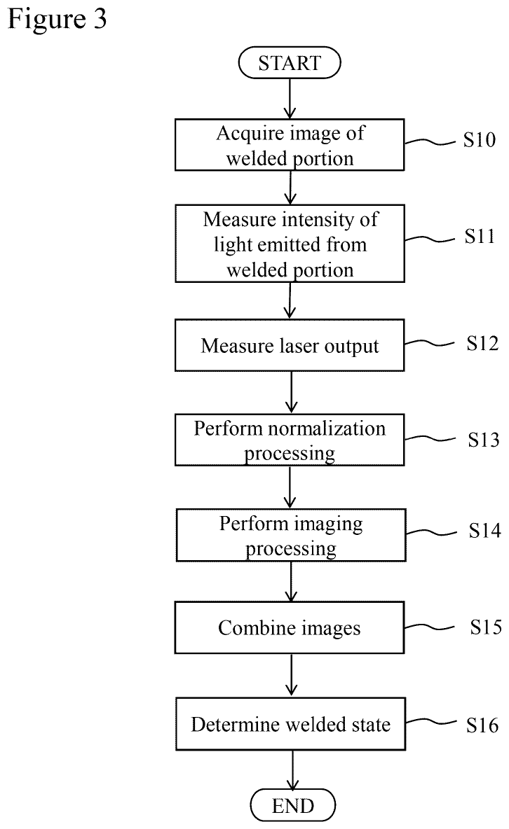

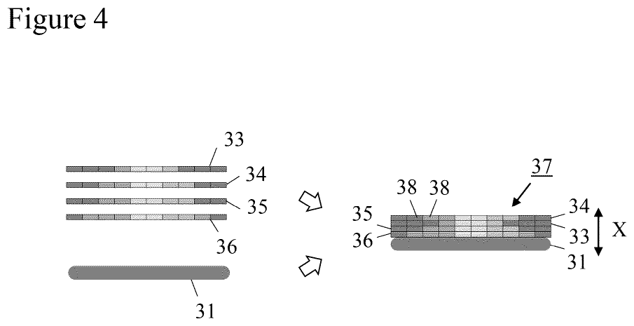

A welded state determination method will now be described in detail by reference to FIGS. 3 and 4. FIG. 3 is a flowchart showing a procedure of a determination method of the present embodiment.

As shown in FIG. 3, the determination method of the present embodiment includes the following steps.
(1) An image acquisition step (S10) of acquiring a first image of the welded portion 102;
(2) A light intensity measurement step (S11) of measuring, along the direction of laser movement, the intensity of light emitted from the welding workpiece (i.e., the sealing assembly 100 and the lead 101) irradiated with the laser, and thereby obtaining measurement data;
(3) An imaging processing step (S14) of imaging the measured light intensity in a manner corresponding to the direction of laser movement and thereby creating a second image; and
(4) A determination step (S16) of determining the state of the welded portion 102 based on an image for determination use containing the first image and the second image.

The determination method of the present embodiment further includes a step (S15) of combining the first image and the second image and thereby creating a combined image. The combined image is then used as the image for determination use in the determination step. In the determination step, the state of the welded portion 102 is preferably determined based on training data obtained by performing machine learning of images for determination use. By imaging the measured values of the intensity of light emitted from the welded portion 102 and providing the imaged result to the third processing unit 13 in the form of a combined image which is a single piece of data combining multiple images, the accuracy of machine learning is improved, and consequently the accuracy of welded state determination is improved.

The determination method of the present embodiment further includes a step (S13) of normalizing the measured light intensity and thereby creating imaging parameters. In that case, the parameters are used in the imaging processing step S14 to create the second image. There may be cases where measured values of plasma light, thermal radiation light, and reflected light are on very different scales, and if such values are used as is to create an image, it is expected that the machine learning accuracy will decrease or the learning will take a long time. For this reason, it is preferable to, for example, perform normalization to place the measurement data on a common scale.

The determination method of the present embodiment further includes a step (S12) of measuring, along the direction of laser movement, the output of the laser irradiated onto the welding workpiece. For example, the laser oscillator 50 measures the emitted laser output. Alternatively, a laser power meter may be provided in the laser head 52 or the like. The measured values of the laser output, as with the measured values of plasma light and the like, are normalized and imaged in a manner corresponding to the direction of laser movement. In step S14, in addition to the second image, a third image is created, which is based on the measured values of the laser output. In that case, the image for determination use contains the first image, the second image, and the third image.

FIG. 4 is a schematic diagram illustrating the determination method of the present embodiment. As shown in FIG. 4, in the determination method of the present embodiment, an image (or original image) of the welding workpiece including the welded portion 102 is captured, and the intensity of light emitted from the welded portion 102 is measured to obtain measurement data. The original image is captured by the camera 20 after, for example, completion of the welding process, and the image data is transmitted to the first processing unit 11. Here, the image of the welded portion 102 may be acquired in real time during the welding process. The first processing unit 11 performs trimming processing to remove unnecessary parts from the original image and allow only the image of the welded portion 102 to remain, and thereby creates a first image 31 of the welded portion 102.

The measurement data is acquired, for example, in real time during the welding process. The acquired measurement data is then subjected to normalization processing and subsequently imaged. The measurement data imaged in the imaging processing step includes, as described above, measured values of the intensity of plasma light, thermal radiation light, and reflected laser light obtained by spectrally dispersing the light emitted from the welding workpiece irradiated with the laser. The intensity of each light is measured in real time during welding by the sensor 21 and the spectroscopic unit 22 along the direction of laser movement, i.e., along the length direction of the welded portion 102. The measurement data further includes measured values of laser output measured in real time along the direction of laser movement.

The normalization processing and the imaging processing for each set of measurement data are as outlined below.
(1) The maximum and minimum values are extracted from the measured values constituting the set of measurement data.
(2) A conversion formula is determined, which serves to convert the measured values such that the maximum value becomes 255 (density value of white) and the minimum value becomes 0 (density value of black).
(3) According to the above conversion formula, the respective measured values are converted into numerical values in the range from 0 to 255. The numerical values in the range from 0 to 255 are the imaging parameters in step S13 in FIG. 3.
(4) The measurement data is imaged by repeatedly performing the process of assigning a shade of color to one converted numerical value (a value in the range from 0 to 255) according to the magnitude of the numerical value and placing the shade of color as one pixel in a sequence. That is, the sets of measurement data composed of the measured values of light intensity and the measured values of laser output are converted into sets of image data.

By performing the above processes (1) to (4) on all sets of measurement data, there are created a second image 33 based on the measured values of plasma light, a second image 34 based on the measured values of thermal radiation light, a second image 35 based on the measured values of reflected laser light, and a third image 36 based on the measured values of laser output. Then, the first image 31 of the welded portion 102 captured by the camera 20, the second images 33, 34, 35, and the third image 36 are combined to create a combined image 37, which is a single image for determination use. When creating an image representing wide-ranging data, it is preferable to perform pooling processing to reduce the number of pixels.

The normalization processing and the imaging processing of the measurement data are executed in the second processing unit 12. The second processing unit 12 acquires measured intensity values of the respective lights at, for example, measurement points set along the direction of laser movement. That is, the measured intensity values of the respective lights are acquired at the same measurement points for the respective lights. The number of measurement points is not particularly limited, and several thousands to several tens of thousands of points may be set in a row along the direction of laser movement. As for the measured laser output values, measurements are likewise made at the same points as the measurement points for the respective lights.

In the determination method of the present embodiment, the combined image 37 is transmitted to the third processing unit 13, and welding quality determination is performed. This determination step is preferably performed based on training data obtained by performing machine learning of combined images 37. The third processing unit 13 determines the quality of the welded portion 102 from the acquired combined image 37 by, for example, using an AI model for images. That is, the combined image 37 is provided as an input value to the AI model. Here, as the AI model, it is possible to use a commercially available software for images, and a conventional AI model can be utilized as is. In other words, according to the determination method of the present embodiment, by creating images from various data having different scales and dimensions, detection of abnormalities from a broad perspective is facilitated, which is a strong point of AL.

As shown in FIG. 4, the combined image 37 is configured as one piece of data in which the first image 31, the second images 33, 34, 35, and the third image 36 are aligned and arranged without overlapping each other. As described above, each of the images is composed of a plurality of pixels 38 arranged in a row along the direction of laser movement, and has a length direction and a width direction. FIG. 4 only schematically shows the combined image 37, and each of the second images 33, 34, 35 and the third image 36 has, for example, along the length direction of the image, several thousands to several tens of thousands of pixels 38 corresponding to the above-described measurement points. Meanwhile, in the width direction, each of those images is composed of one pixel 38.

The combined image 37 is configured by arranging the respective images such that the width direction of the images is oriented along the direction X in which the images are arranged. Further, pixels 38 (imaging parameters) of the respective images based on numerical data corresponding to the same measurement point are arranged to align along the X direction. In the example shown in FIG. 4, the images constituting the combined image 37 are arranged in the following order: the first image 31 captured by the camera 20, the third image 36 of the measured values of laser output, the second image 35 of reflected laser light, the second image 33 of plasma light, and the second image 34 of thermal radiation light. However, the order of the images is not limited to this, and is appropriate so long as the AI model can recognize the images as a single piece of data. It is also possible to construct the combined image 37 by overlapping the sets of image data.

As noted above, determination of the quality of the welded portion 102 using the combined image 37 is preferably performed based on training data obtained by machine learning of AI. For the machine learning, a conventionally known method can be applied, and no particular limitation is imposed on the method. Further, the machine learning includes deep learning. For example, non-defective and defective patterns of the welded portion 102 are input to the third processing unit. Then, by having an AI perform machine learning of those patterns, welding quality determination by the AI becomes possible. In the determination step, the combined image 37, which is one piece of data, is input to the AI model, and presence or absence of abnormality is determined based on the training data.

For example, the AI model sets parameters used in machine learning, such as the image size and number of images for convolution processing, selection of a convolution filter, selection of an activation filter, selection of a thinning filter, the size and number of images for thinning processing, the intermediate layer size and number of layers for perceptron combination processing, the dropout rate, and the number of epochs. Further, based on the training data resulting from the machine learning and also based on the combined image 37, the AI model determines the welded state in real time.

The AI model reads image data for training use to perform, at an initial stage, machine learning based on preset initial parameters, and after that perform machine learning based on parameters calculated by learning. For example, coefficients for weighting numerical values of respective pixels 38 of the image, a threshold value, an offset value, and the like are varied, and weighting coefficients and the like that maximize the probability of correctly identifying welded states are eventually determined. In the case of deep learning, layers that perform local weighting may be included, and layers that perform global weighting may be included.

For example, the AI model checks the combined image 37 against the training data, and determines the degree of coincidence with each of various welded states. Then, the respective determined results of degree of coincidence are weighted or are evaluated using a threshold value to thereby comprehensively determine the degrees of coincidence with various welded states, and a welded state with the highest degree of coincidence is determined.

The advantageous effects of the determination method of the present embodiment include the following points.
(1) By creating an image from sets of numerical data, there is no need to use a complex AI model capable of handling the respective sets of data, and an AI model capable of only handling image data can be used.
(2) In an image, a plurality of sets of numerical data can be visually perceived uniformly as density values (of black, gray, and white). By performing comparisons with surrounding values in the image, it is possible to focus only on an amount of change in each set of data.
(3) By performing pooling processing on image data, it is possible to perform analysis by narrowing down the range of data analysis from a broad range to a unit such as a month, day, or hour.
(4) By imaging the numerical data, the resulting data have two-dimensional positional relationships, so that it is possible to perform analysis focusing on information contained in the positional relationships.
(5) As techniques for processing image data, not only AI models but various image processing techniques have already been developed, and those techniques can also be used to perform analysis. Depending on the analysis technique, it is possible to focus only on gradual changes or only on steep changes, or to remove noise data.
(6) Since image data can also be easily visually perceived by humans, wide-ranging data can be checked at a glance.

As described above, according to the determination method of the present embodiment, highly accurate quality determination is possible by imaging numerical data such as the intensity of light emitted from a welding workpiece irradiated with a laser, and using the resulting image together with an image of the welded portion for determining the welded state. In addition, the above-described imaging facilitates application of various analysis techniques including AI models. When an AI model is used to perform quality determination, it is easy to determine a welded state in a multifaceted approach.

It is noted that rapid changes in temperature and state of matter occur in laser-welded portions, and analysis of a welded state is not easy. Optimization of parameters related to laser welding is therefore achieved relying on accumulated results of trial and error. Further, during mass production, welding defects such as spatters and holes can occur due to various combinations of factors. For these reasons, in the determination method of the present embodiment, various wide-ranging data are acquired and used as input values in the determination step. Here, one problem that would arise when using various data as input values is that the data formats and scales differ. By imaging the numerical data and inputting the resulting data in the form of image data into an AI model, it becomes possible to perform welding quality determination in a multifaceted approach and in a highly accurate manner.

The present disclosure is further illustrated by the following embodiments.

Configuration 1: A welded state determination method for determining a welded state of a welded portion that has been melted and solidified by moving a laser relative to a welding workpiece and irradiating the laser onto the welding workpiece, the determination method comprising: a step of acquiring a first image which is an image of the welded portion; a step of measuring, along a direction of movement of the laser, intensity of light emitted from the welding workpiece irradiated with the laser; an imaging processing step of imaging measured values of the intensity of the light in a manner corresponding to the direction of movement of the laser and thereby creating a second image; and a determination step of determining a state of the welded portion based on an image for determination use containing the first image and the second image.

Configuration 2: The welded state determination method according to Configuration 1, further comprising a step of normalizing the measured values of the intensity of the light and thereby creating imaging parameters, wherein, in the imaging processing step, the parameters are used to create the second image.

Configuration 3: The determination method according to Configuration 1 or 2, further comprising a step of combining the first image and the second image to create the image for determination use.

Configuration 4; The determination method according to any one of Configurations 1 to 3, wherein the measured values of the intensity of the light that are imaged in the imaging processing step include measured values of intensity of plasma light obtained by spectrally dispersing the light emitted from the welding workpiece.

Configuration 5: The determination method according to any one of Configurations 1 to 4, wherein the measured values of the intensity of the light that are imaged in the imaging processing step include measured values of intensity of thermal radiation light obtained by spectrally dispersing the light emitted from the welding workpiece.

Configuration 6: The determination method according to any one of Configurations I to 5, wherein the measured values of the intensity of the light that are imaged in the imaging processing step include measured values of intensity of reflected light of the laser obtained by spectrally dispersing the light emitted from the welding workpiece.

Configuration 7: The determination method according to any one of Configurations 1 to 6, further comprising a step of measuring, along the direction of laser movement, an output of the laser irradiated onto the welding workpiece, wherein, in the imaging processing step, measured values of the output of the laser are imaged in a manner corresponding to the direction of movement of the laser and a third image is thereby created, and the image for determination use contains the third image in addition to the first image and the second image.

Configuration 8: The welded state determination method according to any one of Configurations 1 to 7, wherein, in the determination step, the state of the welded portion is determined based on training data obtained by performing machine learning of images for determination use.

Configuration 9: A welded state determination system for determining a welded state of a welded portion that has been melted and solidified by moving a laser relative to a welding workpiece and irradiating the laser onto the welding workpiece, the determination system comprising: an image acquisition means configured to acquire a first image which is an image of the welded portion; a light intensity measuring means configured to measure, along a direction of movement of the laser, intensity of light emitted from the welding workpiece irradiated with the laser; an imaging processing means configured to image measured values of the intensity of the light in a manner corresponding to the direction of movement of the laser and thereby create a second image; and a determination means configured to determine a state of the welded portion based on the first image and the second image.
10 Determination system; 11 First processing unit; 12 Second processing unit; 13 Third processing unit; 20 Camera; 21 Sensor; 22 Spectroscopic unit; 31 First image; 33, 34, 35 Second image; 36 Third image; 37 Combined image; 38 Pixel; 50 Laser oscillator; 51 Optical fiber; 52 Laser head; 53 Mirror; 100 Sealing assembly; 101 Lead; 102 Welded portion.

1. A welded state determination method for determining a welded state of a welded portion that has been melted and solidified by moving a laser relative to a welding workpiece and irradiating the laser onto the welding workpiece, the determination method comprising:
a step of acquiring a first image which is an image of the welded portion;
a step of measuring, along a direction of movement of the laser, intensity of light emitted from the welding workpiece irradiated with the laser;
an imaging processing step of imaging measured values of the intensity of the light in a manner corresponding to the direction of movement of the laser and thereby creating a second image; and
a determination step of determining a state of the welded portion based on an image for determination use containing the first image and the second image.

2. The welded state determination method according to claim 1, further comprising
a step of normalizing the measured values of the intensity of the light and thereby creating imaging parameters, wherein
in the imaging processing step, the parameters are used to create the second image.

3. The determination method according to claim 1, further comprising
a step of combining the first image and the second image to create the image for determination use.

4. The determination method according to claim 1, wherein
the measured values of the intensity of the light that are imaged in the imaging processing step include measured values of intensity of plasma light obtained by spectrally dispersing the light emitted from the welding workpiece.

5. The determination method according to claim 1, wherein
the measured values of the intensity of the light that are imaged in the imaging processing step include measured values of intensity of thermal radiation light obtained by spectrally dispersing the light emitted from the welding workpiece.

6. The determination method according to claim 1, wherein
the measured values of the intensity of the light that are imaged in the imaging processing step include measured values of intensity of reflected light of the laser obtained by spectrally dispersing the light emitted from the welding workpiece.

7. The determination method according to claim 1, further comprising
a step of measuring, along the direction of laser movement, an output of the laser irradiated onto the welding workpiece, wherein
in the imaging processing step, measured values of the output of the laser are imaged in a manner corresponding to the direction of movement of the laser, and a third image is thereby created, and
the image for determination use contains the third image in addition to the first image and the second image.

8. The determination method according to claim 1, wherein
in the determination step, the state of the welded portion is determined based on training data obtained by performing machine learning of images for determination use.

9. A welded state determination system for determining a welded state of a welded portion that has been melted and solidified by moving a laser relative to a welding workpiece and irradiating the laser onto the welding workpiece, the determination system comprising:
an image acquisition means configured to acquire a first image which is an image of the welded portion;
a light intensity measuring means configured to measure, along a direction of movement of the laser, intensity of light emitted from the welding workpiece irradiated with the laser;
an imaging processing means configured to image measured values of the intensity of the light in a manner corresponding to the direction of movement of the laser and thereby create a second image; and
a determination means configured to determine a state of the welded portion based on the first image and the second image.
